(19) United States
(12) Patent Application Publication
(10) Pub. No.: US 2012/0242904 A1
(43) Pub. Date: Sep. 27, 2012

(54) DISPLAY APPARATUS

(75) Inventors: Kazuyuki SHIRAI, Shijonawate City (JP); Naohiro MIZUMATA, Hirakata City (JP)

(73) Assignee: SANYO ELECTRIC CO., LTD., Osaka (JP)

(21) Appl. No.: 13/409,700

(22) Filed: Mar. 1, 2012

(30) Foreign Application Priority Data
Mar. 25, 2011 (JP) 2011-067341

(51) Int. Cl. H04N 5/14

(52) U.S. Cl. 348/673; 348/E05.062

(57) ABSTRACT

Provided is a display apparatus that performs an adjustment of brightness of a backlight on a per block basis based on a video signal and displays, by using the backlight, an image based on the video signal. The display apparatus includes an adjustment portion that performs an adjustment of a color gain or sharpness with respect to the video signal, and a color gain level or a sharpness level to be achieved by the adjustment for each block is determined in accordance with a degree of the adjustment of brightness performed in the each block.

### CROSS-REFERENCE TO RELATED APPLICATIONS

The present application is based on Japanese Patent Application No. 2011-067341 filed in Japan on Mar. 25, 2011, all the contents of which are hereby incorporated by reference.

### BACKGROUND OF THE INVENTION

1. Field of the Invention

The present invention generally relates to a display apparatus that displays images, and particularly relates to a display apparatus that performs an image quality adjustment.

2. Description of Related Art

There has been conventionally disclosed a display apparatus having a local dimming function. Local dimming refers to a technique in which an image display region is divided into a plurality of blocks, and backlight brightness is adjusted on a per block basis in accordance with a video signal. A level of backlight brightness in a block corresponding to a dark area in an image is set to be low, and thus a reduction in power consumption and an improvement in contrast are achieved.

As described above, according to local dimming, backlight brightness is adjusted on a per block basis. When attention is focused on image quality of an image, particularly with regard to image quality factors such as a color density and a sharpness characteristic, the respective degrees thereof vary depending on a level of backlight brightness. This brings about a situation in which image quality defined by such factors varies from block to block in a display apparatus in which local dimming is performed.

In general, as for a color density, there is a trend that a block in which a high level of backlight brightness is obtained exhibits a light color and a block in which a low level of backlight brightness is obtained exhibits a dark color. Furthermore, as for a sharpness characteristic, there is a trend that a block in which a high level of backlight brightness is obtained exhibits a weak degree of sharpness and a block in which a low level of backlight brightness is obtained exhibits a strong sharpness characteristic.

### SUMMARY OF THE INVENTION

A display apparatus according to the present invention is a display apparatus that performs an adjustment of brightness of a backlight on a per block basis based on a video signal and displays, by using the backlight, an image based on the video signal. The display apparatus includes a color gain adjustment portion that performs a color gain adjustment with respect to the video signal, and a color gain level to be achieved by the color gain adjustment for each block is determined in accordance with a degree of the adjustment of brightness performed in the each block.

Furthermore, in another aspect, a display apparatus according to the present invention is a display apparatus that performs an adjustment of brightness of a backlight on a per block basis based on a video signal and displays, by using the backlight, an image based on the video signal. The display apparatus includes a sharpness adjustment portion that performs a sharpness adjustment with respect to the video signal, and a sharpness level to be achieved by the sharpness adjustment for each block is determined in accordance with a degree of the adjustment of brightness performed in the each block.

### DESCRIPTION OF DRAWINGS

The object and features of the present invention can be further clarified by referring to the following description of preferred examples and the appended drawings showing the following.

FIG. 1 is a diagram showing a configuration of a television receiver according to each of embodiments of the present invention.

FIG. 2 is an explanatory diagram regarding blocks.

FIG. 3 is an explanatory diagram regarding processing performed by a block-specific APL detection portion.

FIG. 4 is an explanatory diagram regarding adjustment parameters.

### DESCRIPTION OF PREFERRED EMBODIMENTS

By exemplarily using a television receiver having a two-dimensional local dimming function (one form of the display apparatus), the following describes embodiments of the present invention.

### 1. First Embodiment

The description is directed first to one embodiment (first embodiment) of the present invention.

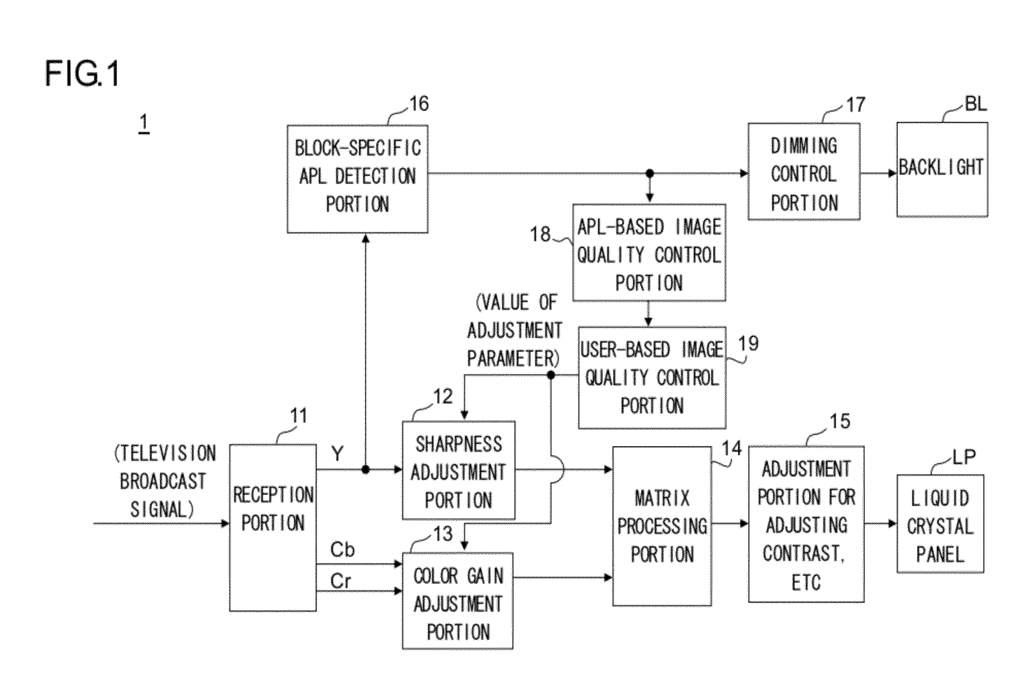

FIG. 1 is a diagram showing a configuration of a television receiver according to this embodiment. As shown in this figure, the television receiver 1 has a backlight BL, a liquid crystal panel LP, a reception portion 11, a sharpness adjustment portion 12, a color gain adjustment portion 13, a matrix processing portion 14, an adjustment portion 15 for adjusting a contrast, etc., a block-specific APL detection portion 16, a dimming control portion 17, an APL-based image quality control portion 18, a user-based image quality control portion 19, and so on.

The backlight BL is disposed on the back side of the liquid crystal panel LP and emits backlight light toward the liquid crystal panel LP. Furthermore, the liquid crystal panel LP has a plurality of pixels and adjusts the degree of transmittance of backlight on a per pixel basis in accordance with a video signal, which is described later. By this configuration, an image is displayed on the liquid crystal panel LP.

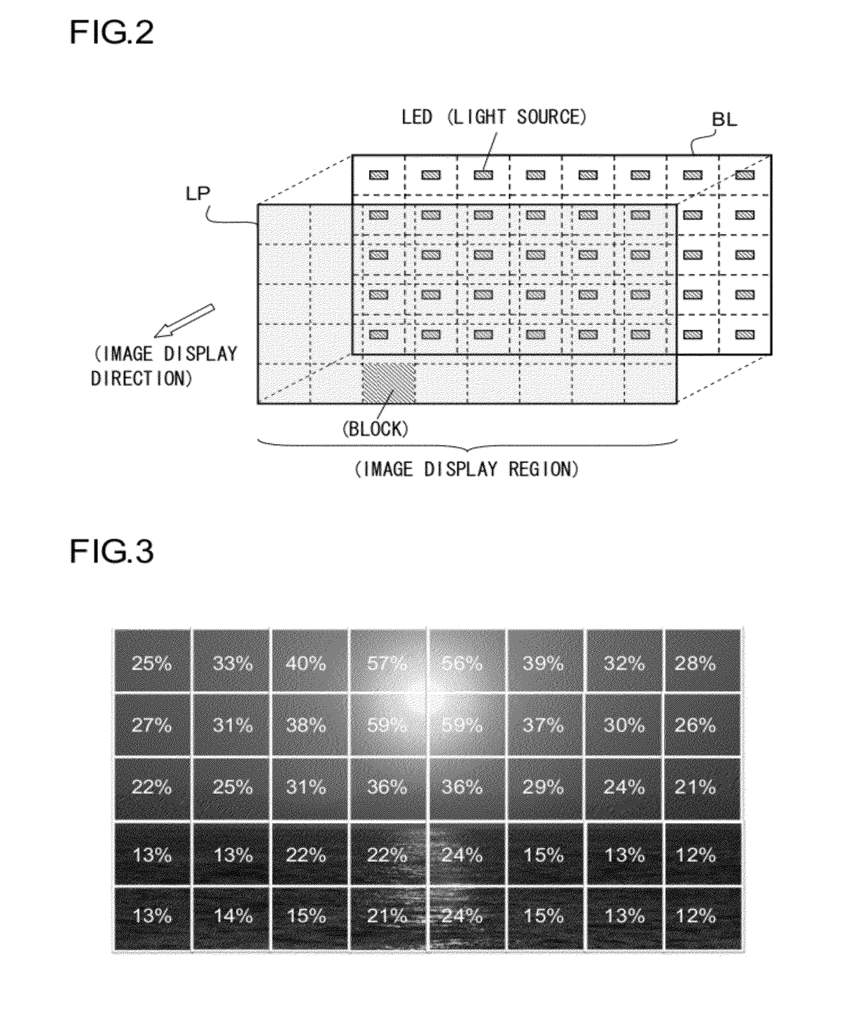

In the television receiver 1, in order to achieve local dimming, an image display region is conceptually divided into a plurality of blocks. This means that, a portion of each of the backlight BL and the liquid crystal panel LP, which coincides with the image display region, is divided into a plurality of blocks as shown by broken lines in FIG. 2. Although, in this embodiment, 40 (five blocks in the vertical direction by eight blocks in the horizontal direction) blocks are obtained by this division as shown in the figure, there is no particular limitation on the number of blocks, the shape of each block, and so on. Any one of the blocks in the backlight BL is identical to one of the blocks in the liquid crystal panel LP, which coincides therewith.

Furthermore, as shown in FIG. 2, the backlight BL has, in each of the blocks, one or a plurality of LEDs (light emitting diodes) used as a backlight light source. The LEDs can be adjusted in terms of an emission luminance (brightness) independently of one another at least on a per block basis.

This configuration allows backlight brightness to be adjusted on a per block basis. A degree of an adjustment of backlight brightness for each of the blocks is reflected particularly on a brightness level of backlight reaching a corresponding one of the blocks in the liquid crystal panel LP. The type of a light source used is not limited to an LED, and any other type of light source may be adopted.

Referring back to FIG. 1, the reception portion 11 receives a television broadcast signal and sends out a video signal representing an image of a television program to a downstream side. A video signal sent out by the reception portion 11 has, as one example, a so-called YCbCr color format. In other words, the reception portion 11 sends out as a video signal, a Y signal (luminance signal), a Cb signal (color difference signal), and a Cr signal (color difference signal). A Y signal is sent out to the sharpness adjustment portion 12 and to the block-specific APL detection portion 16, and a Cb signal and a Cr signal are sent out to the color gain adjustment portion 13, respectively.

The sharpness adjustment portion 12 performs processing of a sharpness adjustment with respect to a video signal (Y signal) sent from the reception portion 11 and sends out the video signal thus processed to the matrix processing portion 14. A sharpness level to be achieved by the sharpness adjustment is determined on the per block basis based on a value of an adjustment parameter α (an adjustment value used as an index of a sharpness level to be achieved by the sharpness adjustment, which is determined on the per block basis), which is described later.

That is, instead of always performing a sharpness adjustment for achieving a uniform sharpness level with respect to a video signal as a whole, with respect to a portion of the video signal to be displayed in a certain block, the sharpness adjustment portion 12 performs a sharpness adjustment for achieving a sharpness level determined for that block. The larger a value of the adjustment parameter α of a block, the higher a sharpness level to be achieved by a sharpness adjustment (a degree of a sharpness characteristic as adjusted) for the block.

The color gain adjustment portion 13 performs processing of a color gain adjustment with respect to a video signal (Cb signal, Cr signal) sent from the reception portion 11 and sends out the video signal thus processed to the matrix processing portion 14. A color gain level to be achieved by the color gain adjustment is determined on the per block basis based on a value of an adjustment parameter β (an adjustment value used as an index of a color gain level to be achieved by a color gain adjustment, which is determined on the per block basis), which is described later.

That is, instead of always performing a color gain adjustment for achieving a uniform color gain level with respect to a video signal as a whole, with respect to a portion of the video signal to be displayed in a certain block, the color gain adjustment portion 13 performs a color gain adjustment for achieving a color gain level determined for that block. The larger a value of the adjustment parameter β of a block, the higher a color gain level to be achieved by a color gain adjustment (a degree of a color density as adjusted) for the block.

A sharpness adjustment is known as processing for adjusting a sharpness characteristic (definition) in an image, and a color gain adjustment is known as processing for adjusting a color density in an image. A sharpness adjustment is achieved, for example, by making a luminance gradient corresponding to an outline in an image (an area in the image, in which a luminance difference exists) steep and by adding a moderate luminance peak to the periphery of the outline. A color gain adjustment is achieved, for example, by controlling a gain of a color difference signal. These types of processing are not particularly limited in terms of how to specifically perform them and so on as long as they do not depart from the respective intended purposes thereof.

The matrix processing portion 14 converts a video signal (Y signal, Cb signal, Cr signal) sent from the sharpness adjustment portion 12 and from the color gain adjustment portion 13 into a video signal in an RGB (red•green•blue) format and sends out the RGB format video signal to a downstream side.

The adjustment portion 15 for adjusting a contrast, etc. performs image quality adjustments such as a contrast adjustment and a brightness adjustment with respect to a video signal sent from the matrix processing portion 14 and sends out the video signal thus processed to a downstream side.

The liquid crystal panel LP is set so that based on a video signal sent from the adjustment portion 15 for adjusting a contrast, etc., the degree of transmittance of backlight is adjusted on a per pixel basis. In the adjustment, a result of an adjustment of backlight brightness performed by the dimming control portion 17 is reflected. In other words, in order that an image can be displayed properly, for example, for a block in which backlight brightness has been adjusted to a low level, the degree of transmittance of backlight is adjusted to be proportionately high.

With respect to a video signal (Y signal) sent from the reception portion 11, the block-specific APL detection portion 16 detects a value of APL (average picture level: average luminance level) (APL value) of each of the blocks. That is, as illustrated in FIG. 3, for each of areas in an image represented by the video signal (areas into which the image is divided so as to correspond to the blocks, respectively), the block-specific APL detection portion 16 performs individual detection of an APL value. Information on a detected APL value of each of the blocks is transmitted to a downstream side.

Based on information on an APL value sent from the block-specific APL detection portion 16, the dimming control portion 17 performs dimming control of the backlight BL. That is, the dimming control portion 17 performs control such that the smaller an APL value of each of the blocks (in other words, the darker an area in an image, which corresponds to each of the blocks), the lower a level of backlight brightness corresponding to the same block. As a result, each of the LEDs included in the backlight BL emits light having a luminance based on the dimming control, and thus local dimming is achieved.

As specific modes of dimming control, various modes can be adopted. In one example of such an adoptable mode, backlight brightness (where a normal level of brightness is assumed to be 100%) is set to 80% (down by 20%) for a block having an APL value of lower than 20%, 90% (down by 10%) for a block having an APL value of not lower than 20% and lower than 30%, 95% (down by 5%) for a block having an APL value of not lower than 30% and lower than 40%, 100% (normal level) for a block having an APL value of not lower than 40% and lower than 50%, and 120% (up by 20%) for a block having an APL value of not lower than 50%.

By using an APL value of each of the blocks, the APL-based image quality control portion 18 controls a sharpness level to be achieved by a sharpness adjustment and a color gain level to be achieved by a color gain adjustment for each of the blocks so that they correspond to a degree of an adjustment of backlight brightness performed in the same block. To be more specific, based on information on an APL value sent from the block-specific APL detection portion 16, the APL-based image quality control portion 18 determines a value of the adjustment parameter α regarding a sharpness adjustment and a value of the adjustment parameter β regarding a color gain adjustment and transmits information on these values to the user-based image quality control portion 19.

By using reference information representing a relationship between an APL value and a value of the adjustment parameter α, a value of the adjustment parameter α is determined such that the higher an APL value of each of the blocks, the larger a value of the adjustment parameter α of the same block. Furthermore, by using reference information representing a relationship between an APL value and a value of the adjustment parameter β, a value of the adjustment parameter β is determined such that the higher an APL value of each of the blocks, the larger a value of the adjustment parameter β of the same block.

As one example of these pieces of reference information, an LUT (look-up table), a relationship equation between an APL value and each of the adjustment parameters, or the like is used, and these pieces of reference information are preset appropriately. Furthermore, one parameter may be used as both the parameters α and β. According to the APL-based image quality control portion 18, in each of the blocks, the higher a level to which backlight brightness is adjusted, the higher a sharpness level to be achieved by a sharpness adjustment and a color gain level to be achieved by a color gain adjustment that are set.

In response to a user's instruction (for example, an operation performed on an unshown operation switch by a user), the user-based image quality control portion 19 controls a sharpness level to be achieved by a sharpness adjustment or a color gain level to be achieved by a color gain adjustment. To be more specific, when an instruction for correcting a sharpness level to be achieved by a sharpness adjustment or a color gain level to be achieved by a color gain adjustment (including an instruction as to the amount of the correction) is issued, in response to this instruction, the user-based image quality control portion 19 corrects a value of either of the adjustment parameters received from the APL-based image quality control portion 18.

Furthermore, the user-based image quality control portion 19 is capable of accepting an instruction that image quality control corresponding to an APL value (control of a sharpness level to be achieved by a sharpness adjustment or a color gain level to be achieved by a color gain adjustment) should be disabled. If such an instruction is issued, the user-based image quality control portion 19 uses, for example, a preset default value of either of the adjustment parameters (that is constant irrespective of an APL value) in place of a value thereof received from the APL-based image quality control portion 18. This allows image control corresponding to an APL value to be disabled.

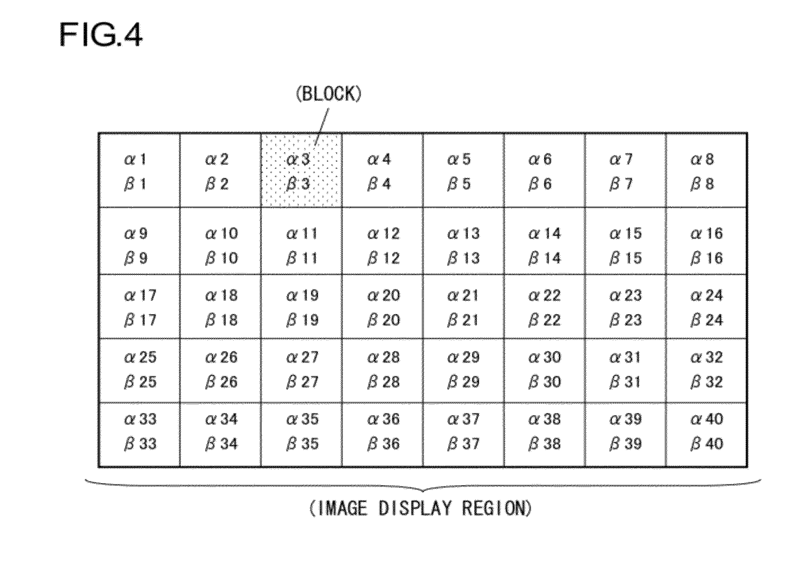

After performing the above-described correction in response to the instruction, the user-based image quality control portion 19 sends out information on the respective values of the adjustment parameters (α, β) to the sharpness adjustment portion 12 and to the color gain adjustment portion 13, respectively. The sharpness adjustment portion 12 thereby obtains 40 values ranging from α1 to α40 as values of the adjustment parameter α. Furthermore, the color gain adjustment portion 13 thereby obtains 40 values ranging from β1 to β40 as values of the adjustment parameter β. As shown in FIGS. 4, an and βn (n is an integer from 1 to 40) indicate values corresponding to an n-th block.

Then, the sharpness adjustment portion 12 performs a sharpness adjustment for achieving a sharpness level corresponding to an updated value of the adjustment parameter α, and the color gain adjustment portion 13 performs a color gain adjustment for achieving a color gain level corresponding to an updated value of the adjustment parameter β.

As for timing at which an updated value of each of the adjustment parameters is obtained sequentially, such updating may be performed at every frame or every plurality of frames (for example, every 10 frames) of a video signal. Furthermore, in order to avoid a sudden change in the adjustment parameters caused when an APL value of a video signal suddenly changes (for example, when scenes of an image switch), the APL-based image quality control portion 18 may be configured to determine a value of each of the adjustment parameters based on, for example, a moving average of APL values of a plurality of frames.

As described above, in the television receiver 1, a sharpness level to be achieved by a sharpness adjustment and a color gain level to be achieved by a color gain adjustment for each of the blocks are determined in accordance with a degree of an adjustment of backlight brightness performed in the same block.

In determining a sharpness level to be achieved by a sharpness adjustment and a color gain level to be achieved by a color gain adjustment for each of the blocks to this effect, instead of using information on an APL value of the same block, information on a degree of an adjustment of backlight brightness performed in the same block may be used directly.

As discussed above, the television receiver 1 of this embodiment performs an adjustment of brightness of a backlight on a per block basis based on a video signal and displays, by using the backlight, an image based on the video signal. The television receiver 1 includes the color gain adjustment portion 13 that performs a color gain adjustment with respect to the video signal and the sharpness adjustment portion 12 that performs a sharpness adjustment with respect to the video signal.

Furthermore, the color gain adjustment portion 13 performs a color gain adjustment such that the higher a level to which backlight brightness is adjusted in each of the blocks, the higher a color gain level to be achieved by the color gain adjustment for the same block. Furthermore, the sharpness adjustment portion 12 performs a sharpness adjustment such that the higher a level to which backlight brightness is adjusted in each of the blocks, the higher a sharpness level to be achieved by the sharpness adjustment for the same block.

That is, with respect to a general trend regarding a color density that a block in which a high level of backlight brightness is obtained exhibits a light color and a block in which a low level of backlight brightness is obtained exhibits a dark color, the color gain adjustment portion 13 adjusts a color gain level to be achieved by a color gain adjustment so as to cancel such a variation. Furthermore, with respect to a general trend regarding a sharpness characteristic that a block in which a high level of backlight brightness is obtained exhibits a weak sharpness characteristic and a block in which a low level of backlight brightness is obtained exhibits a strong sharpness characteristic, the sharpness adjustment portion 12 adjusts a sharpness level to be achieved by a sharpness adjustment so as to cancel such a variation.

Thus, according to the television receiver 1, despite the fact that the television receiver 1 is designed to perform local dimming, a difference in image quality among the blocks is decreased, and thus it is possible to maximally prevent a feeling of strangeness from being given to a viewer.

### 2. Second Embodiment

As described earlier, the television receiver according to the first embodiment adjusts a sharpness level to be achieved by a sharpness adjustment and a color gain level to be achieved by a color gain adjustment on a per block basis. In this respect, however, adjusting a sharpness level to be achieved by a sharpness adjustment and a color gain level to be achieved by a color gain adjustment for each of the blocks completely independently of one another might cause a phenomenon that a difference in image quality in the vicinity of a boundary between adjacent blocks is accentuated, thus giving a feeling of strangeness to a viewer.

As a solution to this problem, a television receiver that is designed to decrease such a difference in image quality, while capitalizing on the advantages of the first embodiment, is described below as another embodiment (second embodiment) of the present invention. The second embodiment is essentially the same as the first embodiment except for a procedure of determining a sharpness level to be achieved by a sharpness adjustment and a color gain level to be achieved by a color gain adjustment. In the following discussion, an emphasis is placed on a difference from the first embodiment, and duplicate descriptions of the same features as those in the first embodiment may be omitted.

In the first embodiment, the sharpness adjustment portion 12 makes a value of the adjustment parameter α of each of the blocks (a value determined in accordance with a degree of an adjustment of backlight brightness performed in the same block) reflected on a sharpness level to be achieved by a sharpness adjustment for the same block as it is as an adjustment value used as an index of a sharpness level to be achieved by the adjustment.

In this respect, in this embodiment, a value of the adjustment parameter α of each of the blocks is handled as an adjustment value (an intermediate adjustment value) provisionally determined in accordance with a degree of an adjustment of backlight brightness performed in the same block. The sharpness adjustment portion 12 corrects the value of the adjustment parameter α of each of the blocks so that a difference between this value and values of the adjustment parameter α of surrounding blocks thereof is reduced, and makes the thus corrected value reflected on a sharpness level to be achieved by a sharpness adjustment.

As one example, the sharpness adjustment portion 12 corrects a value an (n is an integer from 1 to 40) of the adjustment parameter of each of the blocks according to an equation (1) below.

αn′=C₁×αn+C₂×{α(U)+α(R)+α(D)+α(L)}

(where c₁+4×C₂=1) (1)

In the above equation, αn′ indicates a corrected value of αn. Furthermore, α(U), α(R), α(D), and α(L) indicate values before being corrected of the adjustment parameter α of blocks upward, rightward, downward, and leftward adjacent to a block corresponding to αn, respectively. Furthermore, C₁ and C₂ indicate weighting coefficients and are set, for example, such that C₁=0.6 and C₂=0.1. If, for example, there exists no upward adjacent block (if the block as a subject of the correction is a block located in an uppermost row), α(U) could be replaced with αn.

According to the equation (1), assuming that upward, downward, leftward, and rightward adjacent blocks are surrounding blocks, averaging between αn and values of the adjustment parameter of surrounding blocks is performed in consideration of a fixed amount of weighting. By this correction, a difference between a value of the adjustment parameter α of each of the blocks and values of the adjustment parameter α of surrounding blocks thereof is reduced.

Then, in accordance with a corrected value αn′ of the adjustment parameter of each of the blocks, the sharpness adjustment portion 12 determines a sharpness level to be achieved by a sharpness adjustment on the per block basis. Similarly to the first embodiment, the larger a value of αn′ of a block, the higher a sharpness level to be achieved by a sharpness adjustment for the block.

Furthermore, in the first embodiment, the color gain adjustment portion 13 makes a value of the adjustment parameter β of each of the blocks (a value determined in accordance with a degree of an adjustment of backlight brightness performed in the same block) reflected on a color gain level to be achieved by a color gain adjustment for the same block as it is as an adjustment value used as an index of a color gain level to be achieved by the adjustment.

In this respect, in this embodiment, a value of the adjustment parameter β of each of the blocks is handled as an adjustment value (an intermediate adjustment value) provisionally determined in accordance with a degree of an adjustment of backlight brightness performed in the same block. The color gain adjustment portion 13 corrects the value of the adjustment parameter β of each of the blocks so that a difference between this value and values of the adjustment parameter β of surrounding block thereof is reduced, and makes the thus corrected value reflected on a color gain level to be achieved by a color gain adjustment.

That is, as one example, the color gain adjustment portion 13 corrects a value βn (n is an integer from 1 to 40) of the adjustment parameter of each of the blocks according to an equation (2) below.

βn′=C₃βn+C₄×{β(U)+β(R)+β(D)+β(L)}

(where C₃+4×C₄=1) (1)

In the above equation, βn′ indicates a corrected value of βn. Furthermore, β(U), β(R), β(D), and β(L) indicate values before being corrected of the adjustment parameter β of blocks upward, rightward, downward, and leftward adjacent to a block corresponding to βn, respectively. Furthermore, C₃ and C₄ indicate weighting coefficients and are set, for example, such that C₃=0.6 and C₄=0.1. If, for example, there exists no upward adjacent block (if the block as a subject of the correction is a block located in an uppermost row), β(U) could be replaced with βn.

According to the equation (2), assuming that upward, downward, leftward, and rightward adjacent blocks are surrounding blocks, averaging between βn and values of the adjustment parameter of surrounding blocks is performed in consideration of a fixed amount of weighting. By this correction, a difference between a value of the adjustment parameter β of each of the blocks and values of the adjustment parameter β of surrounding blocks thereof is reduced.

Then, in accordance with a corrected value βn′ (n is an integer from 1 to 40) of the adjustment parameter of each of the blocks, the color gain adjustment portion 13 determines a color gain level to be achieved by a color gain adjustment on the per block basis. Similarly to the first embodiment, the larger a value of βn′ of a block, the higher a color gain level to be achieved by a color gain adjustment for the block.

The above-mentioned equations (1) and (2) are used merely as one example and are not limited thereto in terms of equation elements and so on. Furthermore, blocks defined by the term “surrounding blocks” are not limited to four upward, downward, leftward, and rightward adjacent blocks and may refer to, for example, eight blocks further including diagonally proximate blocks.

As discussed above, the television receiver 1 of this embodiment provisionally determines a value (an adjustment value used as an index of a sharpness level to be achieved by a sharpness adjustment) αn of the adjustment parameter α of each of the blocks in accordance with a degree of an adjustment of backlight brightness performed in the same block, and corrects the provisionally determined value αn of each of the blocks so that a difference between this value and provisionally determined values αn of surrounding blocks thereof is reduced. Then, based on a corrected value αn′ thus obtained, a sharpness level to be achieved by a sharpness adjustment is determined.

Furthermore, the television receiver 1 of this embodiment provisionally determines a value (an adjustment value used as an index of a color gain level to be achieved by a color gain adjustment) βn of the adjustment parameter β of each of the blocks in accordance with a degree of an adjustment of backlight brightness performed in the same block, and corrects the provisionally determined value βn of each of the blocks so that a difference between this value and provisionally determined values βn of surrounding blocks thereof is reduced. Then, based on a corrected value βn′ thus obtained, a color gain level to be achieved by a color gain adjustment is determined.

Thus, according to the television receiver 1 of this embodiment, it is possible to suppress, for example, a phenomenon that a difference in image quality in the vicinity of a boundary between adjacent blocks is accentuated, while capitalizing on the advantages of the first embodiment, and thus it is possible to maximally prevent a feeling of strangeness from being given to a viewer.

The embodiments of the present invention having been discussed thus far are not intended to limit the present invention thereto. Furthermore, the embodiments of the present invention may be variously modified without departing from the spirit of the present invention. According to the display apparatus of the present invention, despite the fact that the display apparatus is designed to perform local dimming, a difference in image quality among blocks is easily decreased.

What is claimed is:

1. A display apparatus that performs an adjustment of brightness of a backlight on a per block basis based on a video signal and displays, by using the backlight, an image based on the video signal, comprising:
a color gain adjustment portion that performs a color gain adjustment with respect to the video signal,
wherein a color gain level to be achieved by the color gain adjustment for each block is determined in accordance with a degree of the adjustment of brightness performed in the each block.

2. The display apparatus according to claim 1, wherein
a color gain level to be achieved by the color gain adjustment is determined such that the higher a level to which brightness of the backlight is adjusted, the higher the color gain level to be achieved by the color gain adjustment.

3. The display apparatus according to claim 2, further comprising:
a sharpness adjustment portion that performs a sharpness adjustment with respect to the video signal,
wherein a sharpness level to be achieved by the sharpness adjustment for each block is determined in accordance with a degree of the adjustment of brightness performed in the each block.

4. A display apparatus that performs an adjustment of brightness of a backlight on a per block basis based on a video signal and displays, by using the backlight, an image based on the video signal, comprising:
a sharpness adjustment portion that performs a sharpness adjustment with respect to the video signal,
wherein a sharpness level to be achieved by the sharpness adjustment for each block is determined in accordance with a degree of the adjustment of brightness performed in the each block.

5. The display apparatus according to claim 3, wherein
a sharpness level to be achieved by the sharpness adjustment is determined such that the higher a level to which brightness of the backlight is adjusted, the higher the sharpness level to be achieved by the sharpness adjustment.

6. The display apparatus according to claim 4, wherein
a sharpness level to be achieved by the sharpness adjustment is determined such that the higher a level to which brightness of the backlight is adjusted, the higher the sharpness level to be achieved by the sharpness adjustment.

7. The display apparatus according to claim 1, wherein
an adjustment value used as an index of a color gain level to be achieved by the color gain adjustment for each block is provisionally determined in accordance with a degree of the adjustment of brightness performed in the each block,
the adjustment value provisionally determined for the each block is corrected so that a difference between the adjustment value provisionally determined for the each block and adjustment values provisionally determined for blocks surrounding the each block is reduced, and
based on the adjustment value thus corrected, the color gain level to be achieved by the color gain adjustment is determined.

8. The display apparatus according to claim 2, wherein
an adjustment value used as an index of a color gain level to be achieved by the color gain adjustment for each block is provisionally determined in accordance with a degree of the adjustment of brightness performed in the each block,
the adjustment value provisionally determined for the each block is corrected so that a difference between the adjustment value provisionally determined for the each block and adjustment values provisionally determined for blocks surrounding the each block is reduced, and
based on the adjustment value thus corrected, the color gain level to be achieved by the color gain adjustment is determined.

9. The display apparatus according to claim 3, wherein
an adjustment value used as an index of a color gain level to be achieved by the color gain adjustment for each block is provisionally determined in accordance with a degree of the adjustment of brightness performed in the each block,
the adjustment value provisionally determined for the each block is corrected so that a difference between the adjustment value provisionally determined for the each block and adjustment values provisionally determined for blocks surrounding the each block is reduced, and
based on the adjustment value thus corrected, the color gain level to be achieved by the color gain adjustment is determined.

10. The display apparatus according to claim 3, wherein
an adjustment value used as an index of a sharpness level to be achieved by the sharpness adjustment for each block is provisionally determined in accordance with a degree of the adjustment of brightness performed in the each block,
the adjustment value provisionally determined for the each block is corrected so that a difference between the adjustment value provisionally determined for the each block and adjustment values provisionally determined for blocks surrounding the each block is reduced, and
based on the adjustment value thus corrected, the sharpness level to be achieved by the sharpness adjustment is determined.

11. The display apparatus according to claim 4, wherein
an adjustment value used as an index of a sharpness level to be achieved by the sharpness adjustment for each block is provisionally determined in accordance with a degree of the adjustment of brightness performed in the each block,
the adjustment value provisionally determined for the each block is corrected so that a difference between the adjustment value provisionally determined for the each block and adjustment values provisionally determined for blocks surrounding the each block is reduced, and
based on the adjustment value thus corrected, the sharpness level to be achieved by the sharpness adjustment is determined.

12. The display apparatus according to claim 5, wherein
an adjustment value used as an index of a sharpness level to be achieved by the sharpness adjustment for each block is provisionally determined in accordance with a degree of the adjustment of brightness performed in the each block,
the adjustment value provisionally determined for the each block is corrected so that a difference between the adjustment value provisionally determined for the each block and adjustment values provisionally determined for blocks surrounding the each block is reduced, and
based on the adjustment value thus corrected, the sharpness level to be achieved by the sharpness adjustment is determined.

13. The display apparatus according to claim 6, wherein
an adjustment value used as an index of a sharpness level to be achieved by the sharpness adjustment for each block is provisionally determined in accordance with a degree of the adjustment of brightness performed in the each block,
the adjustment value provisionally determined for the each block is corrected so that a difference between the adjustment value provisionally determined for the each block and adjustment values provisionally determined for blocks surrounding the each block is reduced, and
based on the adjustment value thus corrected, the sharpness level to be achieved by the sharpness adjustment is determined.
